(19) United States
(12) Patent Application Publication
(10) Pub. No.: US 2022/0206703 A1
(43) Pub. Date: Jun. 30, 2022

(54) Particle-lizer Mechanism for Destroying the Functionality of Data Bearing Components of a Solid-State Data Bearing Device

(71) Applicant: Sepehr Rajaie, Reynoldsburg, OH (US)

(72) Inventor: Sepehr Rajaie, Reynoldsburg, OH (US)

(21) Appl. No.: 17/139,881

(22) Filed: Dec. 31, 2020

(51) Int. Cl. G06F 3/06

(52) U.S. Cl. CPC G06F 3/0652; G06F 3/0679; G06F 3/0604

(57) ABSTRACT

The current invention is a Particle-lizer Mechanism for Destroying the Functionality of Data Bearing Components of a Solid-State Data Bearing Device. This particle-lizer mechanism provides destruction of data bearing components from solid-state data bearing devices by reducing the components to particle size of 2 mm or smaller and ensures accurate particle size by use of a screening system to render the data unusable using a simple one stage process. Since there are so few mechanical components in the design, a particle-lizer mechanism can last 100 times longer than a shredding machine with a fraction of the complexity to build. This particle-lizer mechanism is portable and is intended to be used within the customer's secure confines of a data center or enterprise facility. This particle-Ilzer mechanism includes a particle collection system and a filtration system to preserve air quality where it is located.

### CROSS-REFERENCES TO RELATED APPLICATIONS (IF ANY)

None

### BACKGROUND

### 1. Field of the Invention

The present invention relates to mechanism for destroying data bearing components of the solid-state data bearing devices

### 2. Description of Prior Art

Solid-state data bearing devices that eventually fail or are decommissioned are separated from the host server or array or other computer device and need to have the functionality of the solid-state data bearing components destroyed so that the data is no longer usable.

Other systems may not destroy all the data bearing components of the solid-state data bearing device. Other systems may not be used within an organization's secure location.

Other systems may not focus on preserving air quality in the area where they are used. Other systems use a mechanical shredding approach that is not used by the particle-lizer mechanism. The other systems using the shredding technology are larger, bulky mechanisms that utilize multiple stage shredding to reduce the solid-state components.

There is still room for improvement in the art.

### SUMMARY OF THE INVENTION

The present invention is particle-lizer mechanism that provides destruction of data bearing components from solid-state data bearing devices by reducing the components to particle size of 2 mm or smaller and ensures accurate particle size by use of a screening system to render the data unusable using a simple one stage process. Since there are so few mechanical components in the design, a particle-lizer mechanism can last 100 times longer than a shredding machine with a fraction of the complexity to build. This particle-lizer mechanism is portable and is intended to be used within the customer's secure confines of a data center or enterprise facility. This particle-lizer mechanism includes a particle collection system and a filtration system to preserve air quality where it is located.

It is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows a diagram of some of the components of the invention.

### DESCRIPTION OF THE PREFERRED EMBODIMENT

There are a number of significant design features and improvements incorporated within the invention.

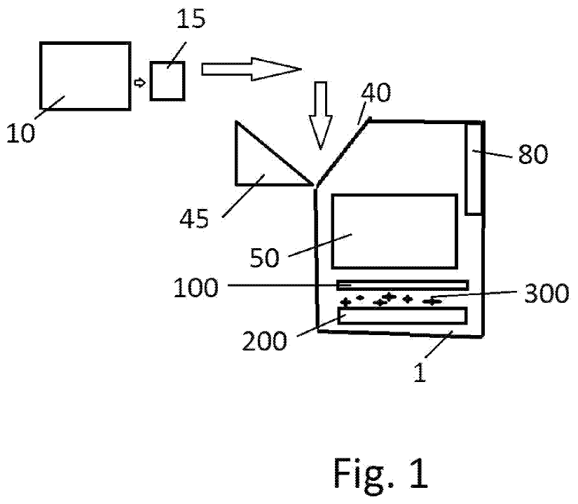

As shown in FIG. 1, the current invention is a particle-lizer mechanism 1 will separate the data bearing components from the circuit board and reduce them to a particle size of 2 mm or smaller in order to flow through a 2 mm screen 100, which per cybersecurity regulations, renders the data unusable. The particle-lizer mechanism 1 uses a new approach to solid state destruction that is more energy efficient and processes more solid-state components in less time with a single stage process. The particles will be collected in a particle collection system 200 within the particle⋅ lizer mechanism 1. The waste particles that become airborne will be collected safely inside the particle⋅ lizer mechanism 1.

Solid-state data bearing devices 10 that eventually fail or are decommissioned are separated from the host server or array or other computer device and need to have the functionality of the solid-state data bearing components destroyed so that the data is no longer usable. The invention claimed here solves this problem.

When the failed or decommissioned solid-state data bearing device 10 is removed from the host server or array or other computer device and is designated for destruction of data, the circuit board of the solid-state device 10 will be removed from the solid-state device 10 and inserted into the particle-lizer mechanism 1.

The particle-lizer mechanism 1 provides destruction of data bearing components from solid-state data bearing devices 10 and ensures accurate particle size to render the data unusable using a single stage process. This particle-lizer mechanism 1 includes a filtration system 80 to preserve air quality where it is located. Also, this particle-lizer mechanism 1 can be produced in a variety of sizes to allow for efficient use and transportation to customers' secure locations.

The particle-lizer components can be configured to produce remnants of different particle sizes based on the screening of the particles 300.

If a circuit board has been inserted into the particle-lizer mechanism 1, then the particle-lizer mechanism 1 will reduce the data bearing components 15 to a particle size of 2 mm or smaller. If the data bearing components 15 have been reduced to a particle size of 2 mm or smaller, the remnants will move through the size filtering screen system 100 which is set for 2 mm or smaller. If the particles 300 from the data bearing components 15 move through the size filtering screen system 100 which is set for 2 mm or smaller, the particles 300 meet the size designated in cybersecurity regulations for making data unusable. If the particles 300 meet the size designated in cybersecurity regulations for making data unusable, then the solid-state components 15 have been determined to be non-functional and the data unreadable.

Other systems do not reduce all data bearing components 15 of a solid-state data bearing device 10 to a particle size of 2 mm or smaller. Other systems perform incomplete destruction since they do not destroy the data on all of the data bearing components 15 of a solid-state data bearing device. Other systems destroy data bearing devices 10 in a location that is outside the secure confines of a data center or enterprise facility, which constitutes a security risk. Other systems may reduce air quality in the areas where they are being used. In existing designs, these current designs require blade sharpening and motor replacements since they are essentially shredders. These other systems overheat and have to be replaced becoming e-waste themselves.

This particle-lizer mechanism 1 provides destruction of data bearing components 15 from solid-state data bearing devices 10 by reducing the components 15 to particle size of 2 mm or smaller and ensures accurate particle size by use of a screening system to render the data unusable using a simple one stage process.

Since there are so few mechanical components in the design, a particle-lizer mechanism 1 can last 100 times longer than a shredding machine with a fraction of the complexity to build. This particle-lizer mechanism 1 is portable and is intended to be used within the customer's secure confines of a data center or enterprise facility. This particle-lizer mechanism 1 includes a particle collection system 200 and a filtration system 80 to preserve air quality where it is located.

Also, it can produce a new method to destroy data on data bearing components 15 of solid-state devices 10.

It can produce a new method to reduce components 15 to a designated particle size and screen to ensure accuracy. It can produce a new method for collection of 2 mm particle size remnants. It can produce a new method for air filtration as part of the particle-lizer mechanism.

The main components of the particle-lizer mechanism 1 are:

1. A Drop-in chute with safety guard 40
2. A Single stage destructive apparatus 50
3. A Size filtering screen system 100
4. A Particle Collection System 200 for containing particles 300 after destruction
5. An Air filtration system 80

### Process

Step 1 begins the process of data destruction after the organization has determined a solid-state data bearing device 10 has reached its end of life and has been processed and designated for destruction. The trained technician inserts the circuit board 15 removed from the solid-state data bearing device 10 into the drop-in chute 40 and closes the safety guard 45. Step 2 is the process that uses the single stage destructive apparatus 50 to reduce the data bearing components 15 from the solid-state data bearing device 10 to particle size of 2 mm or smaller to meet cybersecurity regulations for destruction. Step 3 is the process of filtering the particles 300 through a specified size of screen 100 to ensure that particles moving through the size filtering screen system meet the cybersecurity regulations. Step 4 completes the process by containing the particles of the data bearing components 15 after the data has been reduced to the size needed to meet cybersecurity regulations. Step 5 is a system to filter the air in the area where the particle-lizer is being used to meet OSHA Permissible Exposure Limits.

### Advantages

By following the particle-lizer mechanism's process, the organization can be confident that the data bearing components 15 of the solid-state data bearing device 10 have been reduced to a particle size of 2 mm or smaller rendering the data unusable. This alleviates the potential problem of the organization damaging their brand due to leaks of secure data onto the global network. It solves the insider threat in cybersecurity. It saves the organization time and effort in marketing and answering claims in the legal system regarding secure data breaches. It helps the organization meet cybersecurity regulations and avoid significant fines for non-compliance. It is a simpler machine to process Internet of Things devices 10 that is a durable, single stage mechanism that is not shredders, which require maintenance and have a high failure rate, and therefore become e-waste themselves.

Any organization that wants to securely remove not only digital information, but also immediately destroy mechanical information such as a shape and size of a design by reducing the components to 2 mm or smaller particle size can use this particle-lizer mechanism.

It is a new method to destroy data on data bearing components 15 of solid-state devices 10, a new method to reduce components to a designated particle size and screen to ensure accuracy, a new method for collection of 2 mm particle size remnants and a new method for air filtration as part of the particle-lizer mechanism.

### CONCLUSION

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A device for destroying data:
a mechanism with a drop-in chute, a single stage destructive apparatus, a size filtering screen system and a particle collection system.

2. The device of claim 1 further comprising:
where the data is on a data bearing components.

3. The device of claim 2 further comprising:
where the data bearing components is from a solid-state data bearing devices.

4. The device of claim 1 further comprising:
having an air filtration system.

5. The device of claim 1 further comprising:
the device being portable.

6. The device of claim 1 further comprising:
the device being portable.

7. The device of claim 1 further comprising:
where the drop-in chute has a safety guard.

8. The device of claim 1 further comprising:
where the device can be configured to produce particles of different particle sizes based on the screening of the particles.

9. The device of claim 8 further comprising:
producing a particle size of 2 mm or smaller.

10. A process to destroy data using the device of claim 1.
